(19) United States
(12) Patent Application Publication
(10) Pub. No.: US 2019/0001883 A1
(43) Pub. Date: Jan. 3, 2019

(54) CONTROL SYSTEM

(71) Applicant: JAGUAR LAND ROVER LIMITED, Coventry (GB)

(72) Inventors: HARPREET SINGH, WARWICKSHIRE (GB); LEE SKRYPCHUK, Warwickshire (GB); PHILIP THOMAS, WARWICKSHIRE (GB); ELIZABETH CRUNDALL, WARWICKSHIRE (GB)

(21) Appl. No.: 16/019,097

(22) Filed: Jun. 26, 2018

(30) Foreign Application Priority Data
Jun. 28, 2017 (GB) 1710302.9

(51) Int. Cl. B60Q 9/00; G06K 9/00

(52) U.S. Cl. CPC B60Q 9/00; G06K 9/0061; G06K 9/00604

(57) ABSTRACT

A control system (200; 200′) for enabling operation of a vehicle (300), the control system (200; 200′) comprising: a gaze sensing component (120); a processor (140) communicatively coupled to the gaze sensing component (120); and a controller (160) communicatively coupled to the processor (140); wherein: the gaze sensing component (120) is configured to detect a gaze characteristic of a user of the vehicle (300) and send data representative of the gaze characteristic to the processor (140); the processor (140) is configured to identify a primary indication of intent of the user to operate the vehicle (300) when the user gaze characteristic complies with a predetermined gaze characteristic for a first predetermined time period; and the controller (160) is configured to generate an activation signal (150) to enable operation of the vehicle (300) in dependence on the identified primary indication of intent.

### CROSS REFERENCE TO RELATED APPLICATION

This application claims priority to and the benefit of Great Britain Patent Application No. 1710302.9 filed Jun. 28, 2017, which is incorporated herein by reference in its entirety.

### TECHNICAL FIELD

The present disclosure relates to a control system. Particularly, but not exclusively, the disclosure relates to a control system for enabling operation of a vehicle. Aspects of the invention relate to a controller, to a control system, to a method, to a computer program product and to a vehicle.

### BACKGROUND

There is a need to improve how operation of a vehicle is enabled by a user.

Known systems for enabling operation of a vehicle include a key fob, an actuation button and, optionally, require the engaging of either a brake pedal or a clutch pedal.

The above-described known systems can inconvenience the user and also be unreliable and, thus, decrease the quality of user interaction with the vehicle.

At least in certain embodiments, the present invention seeks to overcome or ameliorate at least some of the shortcomings of prior art arrangements.

### SUMMARY OF THE INVENTION

Aspects and embodiments of the invention provide a control system for enabling operation of a vehicle, a vehicle comprising a control system for enabling operation of a vehicle, a controller for a control system enabling operation of a vehicle, a method for enabling operation of a vehicle, and a computer program product as claimed in the appended claims.

According to an aspect of the invention there is provided a control system for enabling operation of a vehicle, the control system comprising:
a camera;
a processor communicatively coupled to the camera; and
a controller communicatively coupled to the processor;

wherein:
the camera is configured to detect a gaze characteristic of a user of the vehicle and send data representative of the gaze characteristic to the processor;
the processor is configured to identify a primary indication of intent of the user to operate the vehicle when the user gaze characteristic complies with a predetermined gaze characteristic for a first predetermined time period; and
the controller is configured to generate an activation signal to enable operation of the vehicle in dependence on the identified primary indication of intent.

According to another aspect of the invention, there is provided a control system for enabling operation of a vehicle. The control system comprises a gaze sensing component. The control system comprises a processor communicatively coupled to the gaze sensing component. The control system comprises a controller communicatively coupled to the processor.

The gaze sensing component is configured to detect a gaze characteristic of a user of the vehicle. The gaze sensing component is configured to send data representative of the gaze characteristic to the processor.

The processor is configured to identify a primary indication of intent of the user to operate the vehicle when the user gaze characteristic complies with a predetermined gaze characteristic for a first predetermined time period.

The controller is configured to generate an activation signal to enable operation of the vehicle in dependence on the identified primary indication of intent.

Identifying a primary indication of intent of the user to operate the vehicle when the user gaze characteristic complies with a predetermined gaze characteristic for a first predetermined time period reduces the likelihood of identifying a false positive, and, thus provides a more reliable system for enabling operation of a vehicle. In particular, having a first predetermined time period during which a user gaze characteristic has to comply with a predetermined gaze characteristic takes into account the actual intent of a user to operate the vehicle, and avoids the unnecessary sending of the activation signal if a user gaze characteristic matches a predetermined gaze characteristic by mistake or unintentionally.

Optionally, the activation signal enables the vehicle to transition from a lower power mode to a higher power mode. Optionally, the activation signal enables activation of an electric machine of the vehicle. Optionally, the activation signal enables the vehicle to transition into a mode that allows a user to drive the vehicle. Optionally, the activation signal allows the vehicle to transition from a stationary state to a moving state.

Optionally, the controller may be configured to generate a feedback signal to enable feedback to be provided to the user based on the user gaze characteristic. Optionally, the feedback is at least one of the following: visual feedback, audio feedback, and haptic feedback.

Providing feedback to a user increases the level of user interaction with the system and thus, improves user engagement with the system so as to more accurately identify the user's intent to operate the vehicle. The feedback may helpfully instruct the user to comply with the predetermined gaze characteristic for the first predetermined time period.

Optionally, upon identification by the processor that the user gaze characteristic may comply with the predetermined gaze characteristic, the controller is configured to generate a feedback signal to enable feedback representative of approaching a threshold associated with the first predetermined time period.

Optionally, the threshold may be equal to the first predetermined time period.

Optionally, the feedback representative of approaching a threshold associated with the first predetermined time period may be one or more of: a visual timer on a display module of the vehicle; an audio count down or count up; an increasing or decreasing amplitude or frequency of haptic feedback.

Optionally, upon identification by the processor that the user gaze characteristic does not comply with the predetermined gaze characteristic within the first predetermined time period, then the controller is configured to reset the feedback signal.

Optionally, the user gaze characteristic comprises eye movement of the user and the predetermined gaze characteristic comprises predetermined eye movement of the user.

Optionally, the gaze characteristic of a user comprises a gaze direction of the user and the predetermined gaze characteristic comprises a predetermined gaze direction to a predetermined target location, T.

Optionally, the predetermined target location, T, may be chosen by the user.

Optionally, the first predetermined time period is in one or more of the following ranges: 1 second to 10 seconds; 1 second to 5 seconds; 2 seconds to 5 seconds; and 2 seconds to 4 seconds.

The amount of seconds for the first predetermined time period can be set long enough to more accurately identify a user's intent to operate the vehicle and avoid recording a false positive which leads to unnecessarily enabling operation of the vehicle by generating an activation signal. In addition, the amount of seconds for the first predetermined time period can be set short enough to allow for ease of use by a user and a quick process to enable operation of the vehicle.

Optionally, the predetermined target location, T, is an interior location of the vehicle.

Optionally, the interior location is associated with one of the following: an instrument cluster, a steering wheel, a mirror, a dashboard, a glove box, a screen, a portion of a windshield, or an air vent.

Optionally, the user gaze characteristic comprises an iris feature of the user and the predetermined gaze characteristic comprises a predetermined iris feature.

Optionally, the gaze sensing component comprises at least one camera.

Optionally, the control system comprises an input sensing component communicatively coupled to the processor. The input sensing component may be configured to detect an input from the user and send data representative of the input to the processor. The processor may be configured to identify a secondary indication of intent of the user to operate the vehicle when the input from the user complies with a predetermined input condition for a second pre-determined time period. The controller may be configured to generate the activation signal in dependence on the primary indication of intent and the secondary indication of intent.

Identifying a secondary indication of intent beneficially more accurately identifies a user's intent to operate the vehicle and, in doing so, reduces the likelihood of incorrect interpretation that a user wishes to operate the vehicle and unnecessary generation of an activation signal. A more reliable system is therefore provided.

Optionally, the length of the second predetermined time period may be dependent on the proportion of the first predetermined time period that has already passed at the time that the input sensing component detects an input from the user. Optionally, the second predetermined time period may be reduced if the proportion of the first predetermined time period that has already passed falls into at least one of the following ranges: greater than or equal to 75%; greater than or equal to 65%; and greater than or equal to 50%. Optionally, the degree of reduction of the second predetermined time period may fall into at least one of the following ranges: greater than or equal to 20%; greater than or equal to 40%; greater than or equal to 60%.

In this way, the second predetermined time period may be set so that a user is not required to wait as long before operation of the vehicle is enabled if a higher proportion of the first predetermined time period has already passed. This creates a sophisticated system that more accurately pre-empts a user's intent to operate the vehicle, whilst also being easy to use and providing a quick process to enable operation of the vehicle.

Optionally, the input sensing component is one of the following: a capacitive sensor; a pressure sensor; and an audio sensor.

The use of a pressure sensor has the advantage of varying a threshold pressure in dependence of the user preference. The pressure sensor may also be advantageous in reducing the number of false positives.

Optionally, the input sensing component is associated with one of the following: a clutch pedal; a brake pedal, and a steering wheel.

Optionally, the controller is configured to generate the activation signal in dependence on the first predetermined time period and the second predetermined time period satisfying an overlap time period. Using an overlap time period more accurately identifies a user's intent to operate the vehicle, and, in this way, provides a third indication of intent. The predetermined overlap time period requires the user gaze characteristic to comply with the predetermined user gaze characteristic at the same time, and for a certain time period, as the user input complies with a predetermined input condition, and, thus, beneficially increases the reliability of the control system.

Optionally, the length of the overlap time period may be dependent on the proportion of the first predetermined time period that has passed. Optionally, the overlap time period may be reduced if the proportion of the first predetermined time period that has already passed falls into at least one of the following ranges: greater than or equal to 75%; greater than or equal to 65%; and greater than or equal to 50%.

Optionally, the length of the overlap time period may be dependent on the proportion of the second time period that has passed. Optionally, the overlap time period may be reduced if the proportion of the second predetermined time period that has already passed falls into at least one of the following ranges: greater than or equal to 75%; greater than or equal to 65%; and greater than or equal to 50%.

The length of the overlap time period in which (1) the user gaze characteristic must comply with a predetermined gaze characteristic; and (2) the user input must comply with a predetermined input condition, can change dynamically dependent on real-time actions of the user and can thus, beneficially result in quicker and more reliable identification of a user's intent to operate the vehicle.

Optionally, the overlap time period may be equal to the shorter of the first predetermined time period and the second predetermined time period.

The overlap time period being equal to the shortest of the first and second predetermined time periods can reduce the amount of time a user is required to wait to operate the vehicle, whilst also increasing the certainty of the intent of the user to operate the vehicle.

Optionally, the overlap time period is in one or more of the following ranges: 1 second to 10 seconds; 1 second to 5 seconds; 2 seconds to 5 seconds; and 2 seconds to 4 seconds.

Optionally, the controller is configured to generate a feedback signal to enable feedback representative of approaching a threshold associated with the overlap time period.

Optionally, the control system comprises a pre-controller in which the pre-controller is configured to identify an authorised user within the vehicle. The controller may be configured to generate the activation signal after the pre-controller identifies an authorised user.

The identification of an authorised user before generation of the activation signal increases the security of the control system by ensuring the vehicle is not being operated by an unauthorised user.

Optionally, the controller may be configured to not generate the activation signal before the pre-controller identifies an authorised user.

Optionally, the controller may be configured to wait to receive an identification signal from the pre-controller before generating the activation signal.

Optionally, the pre-controller is configured to detect an identification module within the vehicle.

Optionally, the identification module is a key fob or smart key.

According to another aspect of the invention, there is provided a vehicle comprising a control system according to an abovementioned aspect of the invention.

According to a further aspect of the invention, there is provided a method for enabling operation of a vehicle. The method comprises detecting a user gaze characteristic of a user of the vehicle. The method comprises identifying a primary indication of intent of the user to operate the vehicle when the user gaze characteristic complies with a predetermined gaze characteristic for a first predetermined time period. The method comprises generating an activation signal to enable operation of the vehicle in dependence on the primary indication of intent.

Optionally, the method comprises detecting an input from the user of the vehicle. Optionally, the method comprises identifying a secondary indication of intent of the user to operate the vehicle when the input from the user complies with a predetermined input condition for a second predetermined time period. Optionally, the method comprises generating the activation signal to enable operation of the vehicle in dependence on the primary indication of intent and the secondary indication of intent.

According to a further aspect of the invention, there is provided a controller for a control system for enabling operation of a vehicle. The controller is configured to receive an input signal indicative of a primary indication of intent of a user to operate a vehicle. The primary indication of intent may be determined when a user gaze characteristic complies with a predetermined gaze characteristic for a first predetermined time period. The controller may be configured to generate an activation signal to enable operation of the vehicle in dependence on the received input signal.

In an embodiment, the abovementioned controller comprises a processor having an electronic processor including an electrical input for receiving data representative of the gaze characteristic; an electronic memory device electrically coupled to the electronic processor and having instructions stored therein, wherein the processor is configured to access the memory device and execute the instructions stored therein such that it is operable to identify the primary indication of intent of the user to operate the vehicle in dependence on the user gaze characteristic complying with a predetermined gaze characteristic for a first predetermined time period, and to generate an activation signal to enable operation of the vehicle in dependence on said identification; and an electrical output configured to output the activation signal.

According to a further aspect of the present invention there is provided a computer program product comprising instructions which, when a program of the program product is executed by a computer, cause the computer to carry out the method of an above aspect of the present invention. The computer program product may be downloadable from a communication network and/or stored on a computer-readable and/or microprocessor-executable medium.

According to a further aspect of the present invention there is provided a non-transitory computer-readable medium having stored thereon the computer program product of a foregoing aspect of the invention.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic diagram of a controller in accordance with an embodiment of the invention.

FIG. 2 is a schematic diagram of a control system including the controller of FIG. 1, in accordance with an embodiment of the invention.

FIG. 3 is a flow chart of a method in accordance with an embodiment of the invention.

FIG. 4 is a flow chart of a method of a further embodiment of the invention.

FIG. 5 is a schematic diagram of the control system FIG. 2, in accordance with an embodiment of the invention.

FIG. 6 is a schematic illustration of the functions occurring within the set up described in relation to FIG. 5, in accordance with an embodiment of the invention.

FIG. 7 is a schematic diagram showing the method of FIG. 4 in more detail, in accordance with an embodiment of the invention.

FIG. 8 is a flow chart illustrating a further method that can be used in conjunction with the method of FIG. 4 and FIG. 7, in accordance with an embodiment of the invention.

FIG. 9A is an illustration of a human machine interface in accordance with an embodiment of the invention.

FIG. 9B is an illustration of a human machine interface in accordance with an embodiment of the invention.

FIG. 9C is an illustration of a human machine interface in accordance with an embodiment of the invention.

FIG. 9D is an illustration of a human machine interface in accordance with an embodiment of the invention.

FIG. 9E is an illustration of a human machine interface in accordance with an embodiment of the invention.

FIG. 9F is an illustration of a human machine interface in accordance with an embodiment of the invention.

FIG. 10 is a side view of a vehicle in accordance with an embodiment of the invention.

### DETAILED DESCRIPTION

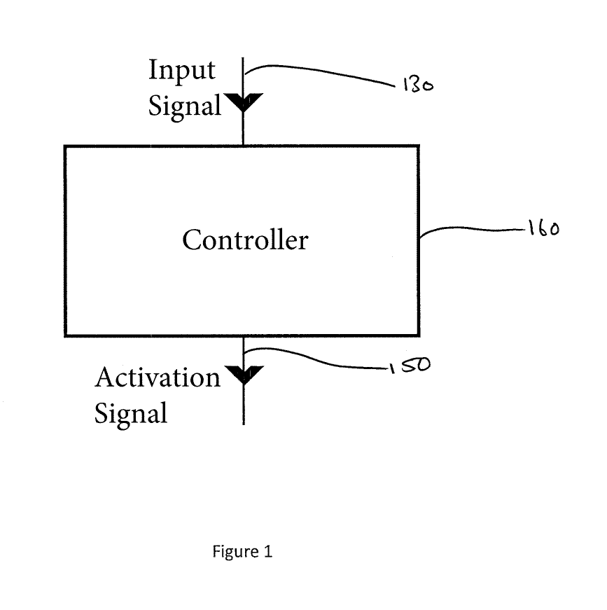

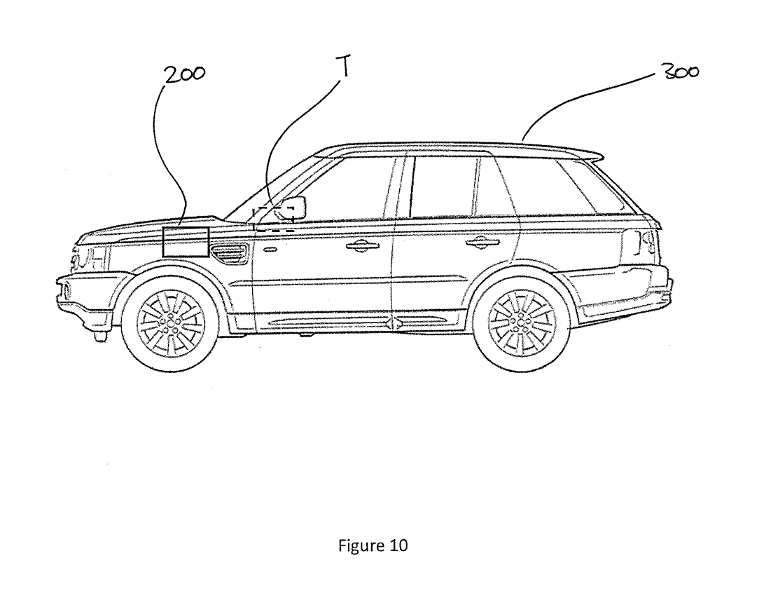

FIG. 1 is a schematic diagram of a controller 160. The controller 160 receives an input signal 130 indicative of a primary indication of intent of a user to operate a vehicle 300 (FIG. 10). The primary indication of intent is determined when a user gaze characteristic complies with a predetermined gaze characteristic for a first predetermined time period. The controller 160 generates an activation signal 150 to enable operation of the vehicle 300 in dependence on the received input signal 130.

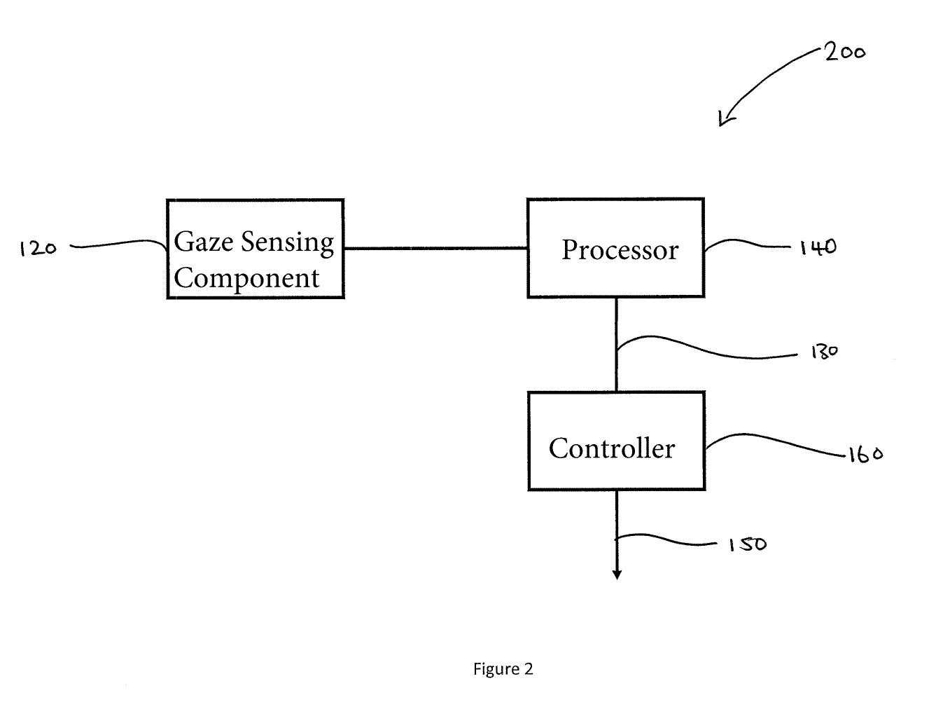

FIG. 2 is a schematic diagram of a control system 200 including the controller 160 of FIG. 1. The control system 200 is provided for enabling operation of a vehicle 300 (FIG. 10). The control system 200 comprises a gaze sensing component 120, a processor 140 communicatively coupled to the gaze sensing component 120, and the controller 160 of FIG. 1 communicatively coupled to the processor 140.

The gaze sensing component 120 detects a gaze characteristic of a user of the vehicle 300 and sends data representative of the gaze characteristic to the processor 140.

The processor 140 identifies a primary indication of intent of the user to operate the vehicle 300 when the user gaze characteristic complies with a predetermined gaze characteristic for a first predetermined time period. The processor 140 sends a signal 130, indicative of a primary indication of intent of the user to operate the vehicle 300, to the controller 160.

As described in relation to FIG. 1, the controller 160 generates an activation signal 150 to enable operation of the vehicle 300 in dependence on the identified primary indication of intent.

Identifying a primary indication of intent of the user to operate the vehicle when the user gaze characteristic complies with a predetermined gaze characteristic for a first predetermined time period reduces the likelihood of identifying a false positive, and, thus provides a more reliable system for enabling operation of a vehicle. In particular, having a first predetermined time period during which a user gaze characteristic has to comply with a predetermined gaze characteristic takes into account the actual intent of a user to operate the vehicle, and avoids the unnecessary sending of the activation signal if a user gaze characteristic matches a predetermined gaze characteristic by mistake or unintentionally.

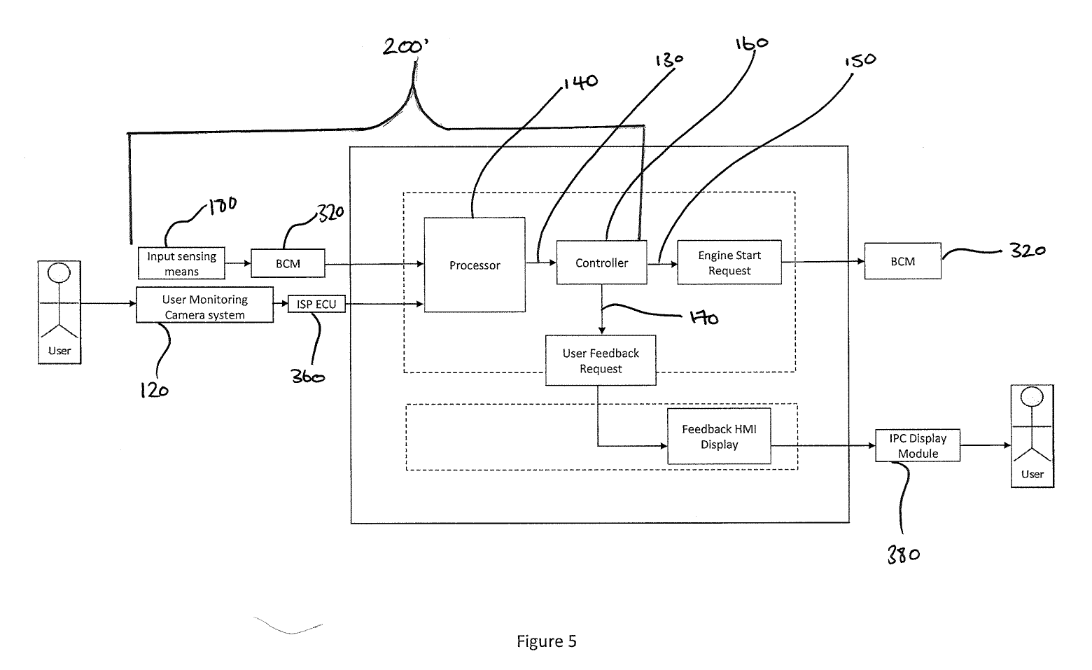

The controller 160 generates a feedback signal 170 (FIG. 5) to enable feedback to be provided to the user based on the user gaze characteristic. The feedback is at least one of the following: visual feedback, audio feedback, and haptic feedback (discussed later in more detail). The controller 160 may generate the feedback signal 170 in response to identification of a primary indication of intent or in response to the user gaze characteristic. Alternatively, the controller 160 may generate the feedback signal 170 when a primary indication of intent is not identified.

Providing feedback to a user increases user interaction with the control system 200 and thus, improves user engagement with the control system 200. The feedback may helpfully instruct the user to perform actions to enable operation of the vehicle 300. This saves time when operating the vehicle 300.

When the feedback signal 170 is generated in response to the user gaze characteristic the feedback signal 170 may enable feedback representative of approaching a threshold associated with the first predetermined time period. The threshold is equal to the first predetermined time period. In this way a user is informed of how much longer the user is required to maintain the user gaze characteristic in order to enable operation of the vehicle 300.

Upon identification by the processor 140 that the user gaze characteristic does not comply with the predetermined gaze characteristic within the first predetermined time period, the controller 160 resets the feedback signal 170.

The gaze characteristic of a user comprises a gaze direction of the user and the predetermined gaze characteristic comprises a predetermined gaze direction to a predetermined target location, T. Additionally, or alternatively the user gaze characteristic is eye movement of the user and the predetermined gaze characteristic is predetermined eye movement of the user. Additionally, or alternatively, the gaze characteristic is an iris feature of the user and the predetermined gaze characteristic is a predetermined iris feature.

The predetermined target location, T, may be chosen by the user.

The first predetermined time period is from 2 seconds up to and including 4 seconds. However, the first predetermined time period may be in one or more of the following ranges: 1 second to 10 seconds; 1 second to 5 seconds; and 2 seconds to 5 seconds.

The duration (e.g. the number of seconds) of the first predetermined time period can be set long enough to avoid recording a false positive and unnecessarily initiating operation of the vehicle 300 through generating an activation signal 150. In addition, duration (e.g. the number of seconds) of the first predetermined time period is set short enough to allow for ease of use by a user and a short activation process of the vehicle 300.

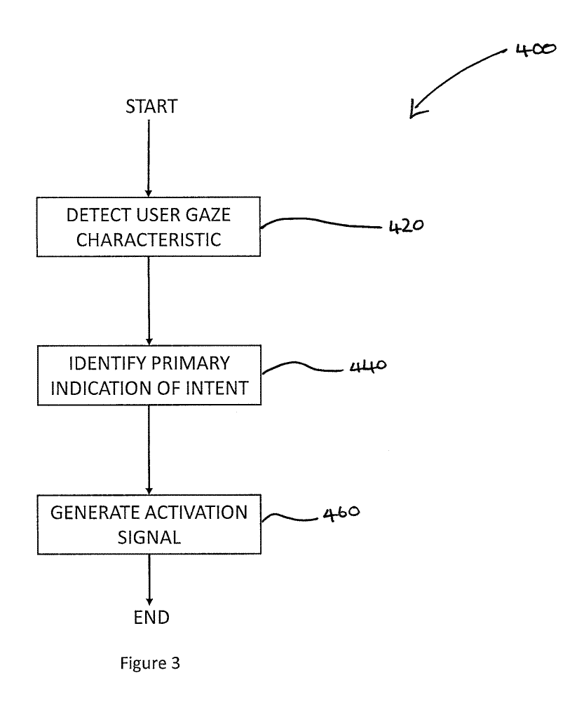

FIG. 3 is a flow chart of a method 400. Method 400 is for enabling operation of a vehicle 300. Method 400 comprises detecting 420 a user gaze characteristic of a user of the vehicle 300, identifying 440 a primary indication of intent of the user to operate the vehicle 300 when the user gaze characteristic complies with a predetermined gaze characteristic for a first predetermined time period, and generating 460 an activation signal 150 to enable operation of the vehicle 300 in dependence on the primary indication of intent.

The control system 200 of FIG. 2 may be modified slightly to include an input sensing component 180 (FIG. 5) referred to as a control system 200′. The input sensing component 180 of the control system 200′ is communicatively coupled to the processor 140. The input sensing component 180 detects an input from the user and sends data representative of the input to the processor 140. The processor 140 identifies a secondary indication of intent of the user to operate the vehicle 300 when the input from the user complies with a predetermined input condition for a second pre-determined time period. The controller 160 generates the activation signal 150 in dependence on the primary indication of intent and the secondary indication of intent.

Identifying a secondary indication of intent beneficially reduces incorrect interpretation that a user wishes to operate the vehicle 300, and, thus, decreases unnecessary generation of an activation signal 150. A more reliable system is therefore provided.

The second predetermined time period may be dependent on the proportion of the first predetermined time period that has already passed at the time that the input sensing component 180 detects an input from the user. In this way, a user is not required to wait the full second predetermined time period before operation of the vehicle 300 is enabled.

The input sensing component 180 is one of the following: a capacitive sensor; a pressure sensor; and an audio sensor. The input sensing component 180 is associated with one of the following: a clutch pedal; a brake pedal, and a steering wheel.

Using the pressure sensor as the input sensing component has a further benefit of reducing the number of false positives. To prevent false positives occurring on the input sensing component, the pressure sensor may have a first threshold for activation and a second threshold for inactivation. The first and second thresholds of the pressure sensor may be set manually by the user or may be set automatically in dependence on a physical property of the user. For example, the physical property may be the user's weight or height. The first and second thresholds of the pressure sensor may be varied by the user in dependence of the user preference. In this way the sensitivity of the pressure sensor may be varied. In this way the sensitivity of the input sensing component may be varied. This aids in providing the user's intent in a clear manner.

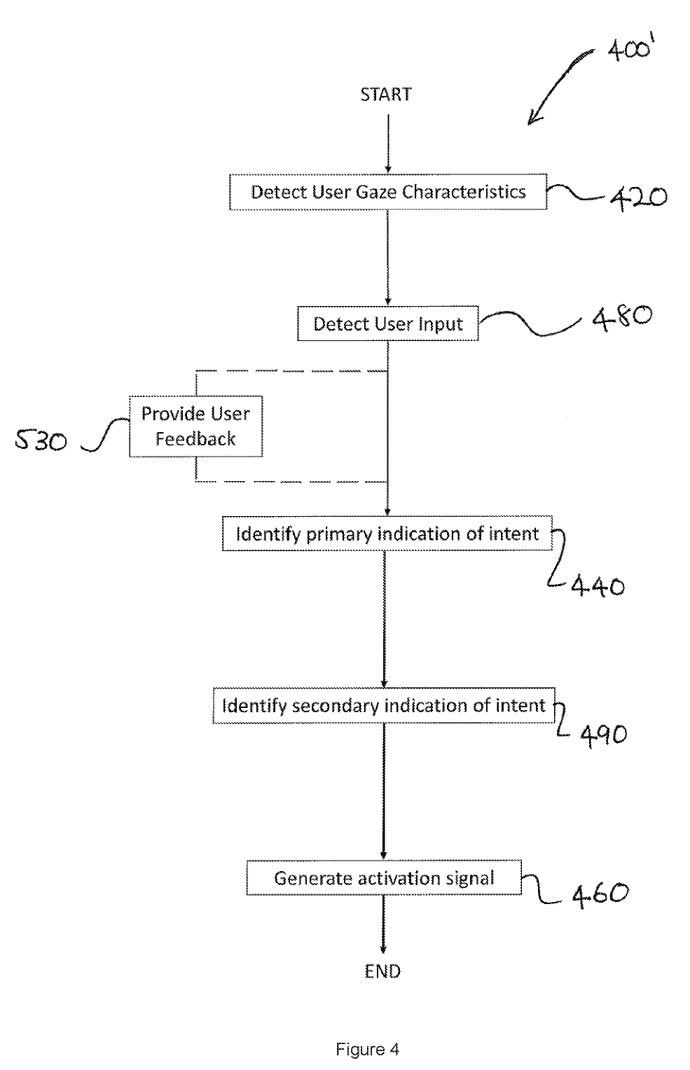

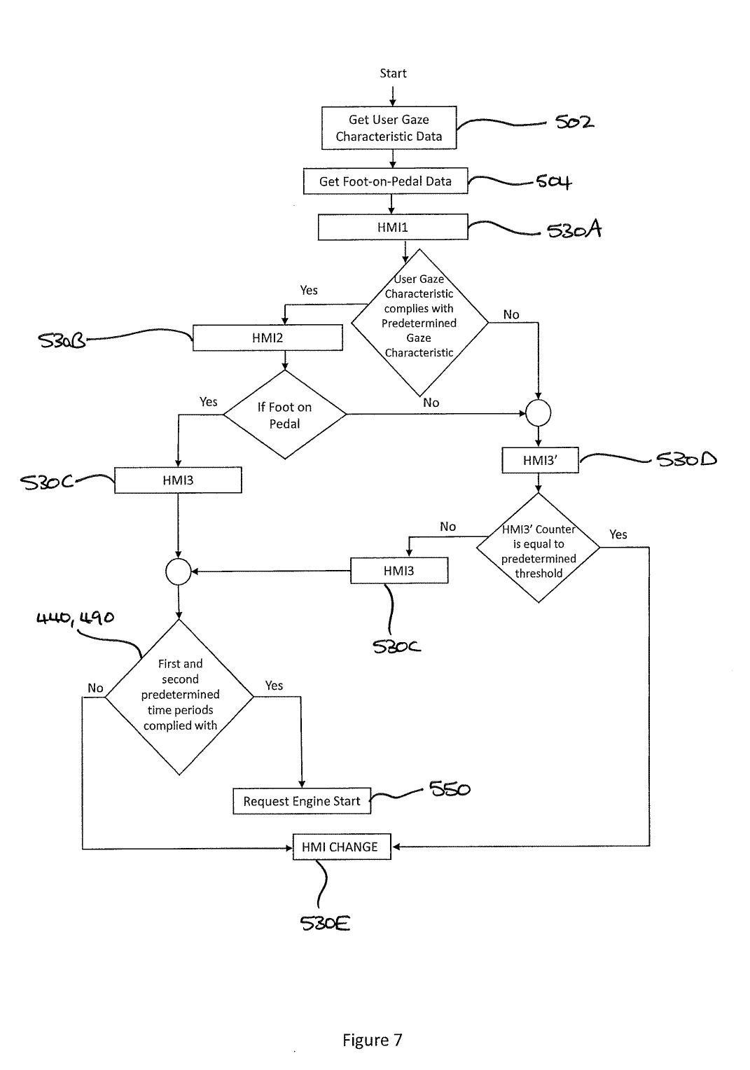

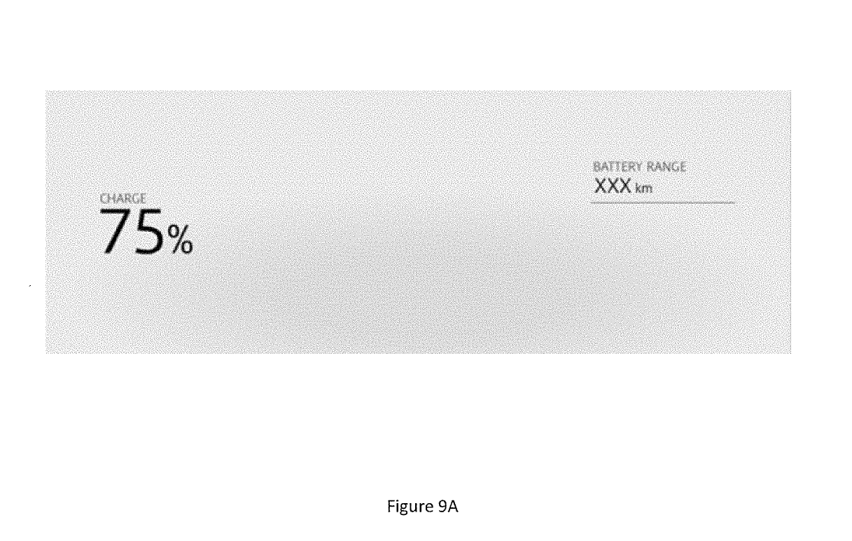

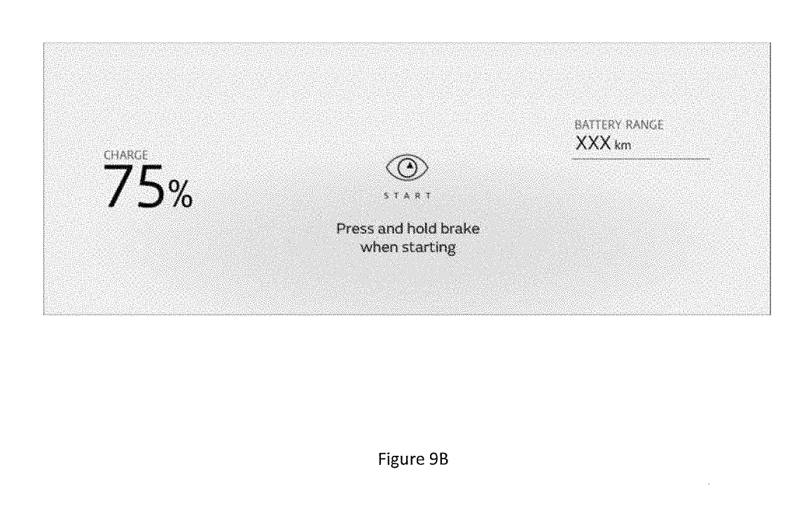

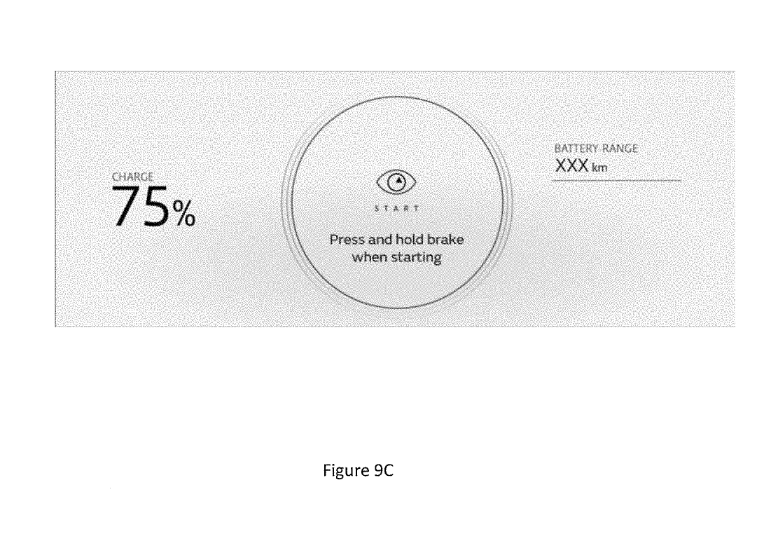

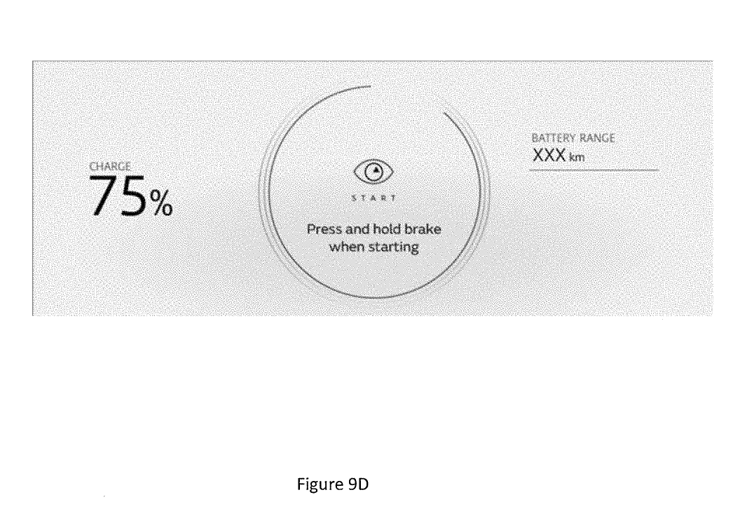

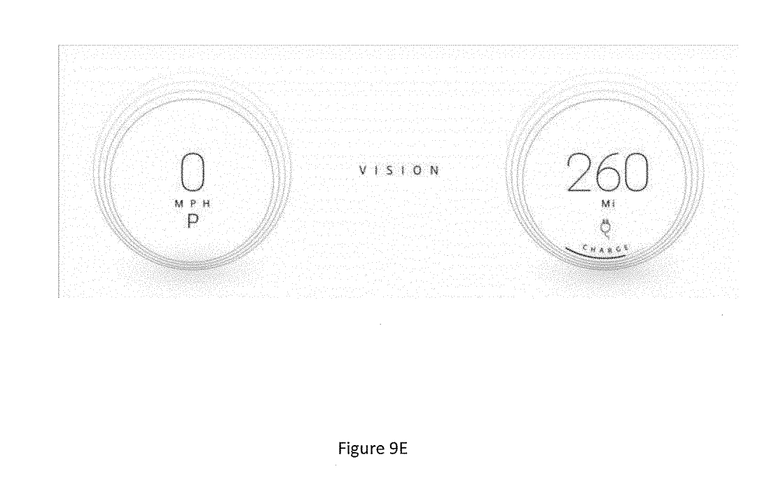

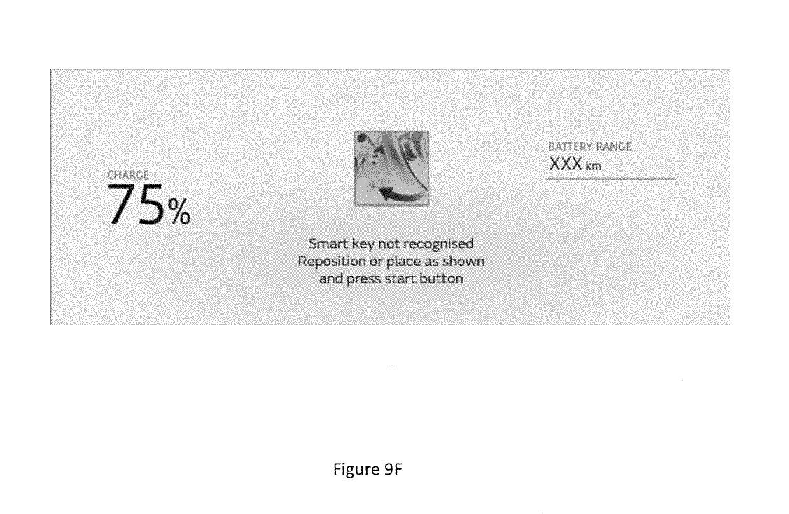

FIG. 4 is a flow chart of a method 400′ of a further embodiment of the invention. Method 400′ of FIG. 4 is a method using the aforementioned modified control system 200′. The method 400′ comprises detecting 420 a user gaze characteristic of a user of the vehicle 300 and detecting 480 an input from the user of the vehicle 300. The method 400′ optionally comprises providing 530 user feedback (see dashed line) dependent on the detected user gaze characteristic and the input from the user. The circumstances under which feedback is provided to the user were discussed briefly in relation to FIG. 2 and are discussed in more detail in relation to FIG. 7 and FIGS. 9A to 9E.

The method 400′ further comprises identifying 440 a primary indication of intent (as described in relation to FIG. 3) and identifying 490 a secondary indication of intent of the user to operate the vehicle 300 when the input from the user complies with a predetermined input condition for a second predetermined time period. Generating 460 the activation signal 150 to enable operation of the vehicle 300 is in dependence on the primary indication of intent and the secondary indication of intent.

FIG. 5 is a schematic diagram of the control system 200′ within a vehicle 300.

The control system 200′ is coupled to components of vehicle 300 (FIG. 10).

In more detail, the gaze sensing component 120 is a user monitoring camera system. The user monitoring camera system is coupled to the Interior Sensing Platform Electronic Control Unit (ISP ECU) 360 of vehicle 300. The ISP ECU 360 is coupled to the processor 140.

The input sensing component 180 is coupled to the Body Control Module (BCM) 320 of vehicle 300. The BCM 320 is coupled to the processor 140. In one embodiment, the input sensing component 180 is a capacitive sensor and is associated with the clutch pedal of vehicle 300.

The user monitoring camera system 120 performs detecting 420 a user gaze characteristic. Data representative of the user gaze characteristic is sent by the ISP ECU 360 to the processor 140.

The input sensing component 180 performs the detecting 480 of a user input. Data representative of the user input is then sent by the BCM 320 to the processor 140.

The processor 140 compares the user gaze characteristic data to a predetermined user gaze characteristic. The processor 140 compares the user input data to a predetermined user input condition.

The processor 140 identifies 440 a primary indication of intent when the user gaze characteristic complies with the predetermined user gaze characteristic for a first predetermined time period. The processor 140 identifies 490 a secondary indication of intent when the user input complies with a predetermined input condition for a second predetermined time period.

The processor 140 sends a signal 130 to the controller 160 in dependence on the identification of the primary and secondary indications of intent.

In dependence on receipt of signal 130, the controller 160 generates an activation signal 150 to enable operation of the vehicle 300. In this embodiment, the activation signal 150 enables an engine start request which is sent to the BCM 320 of vehicle 300.

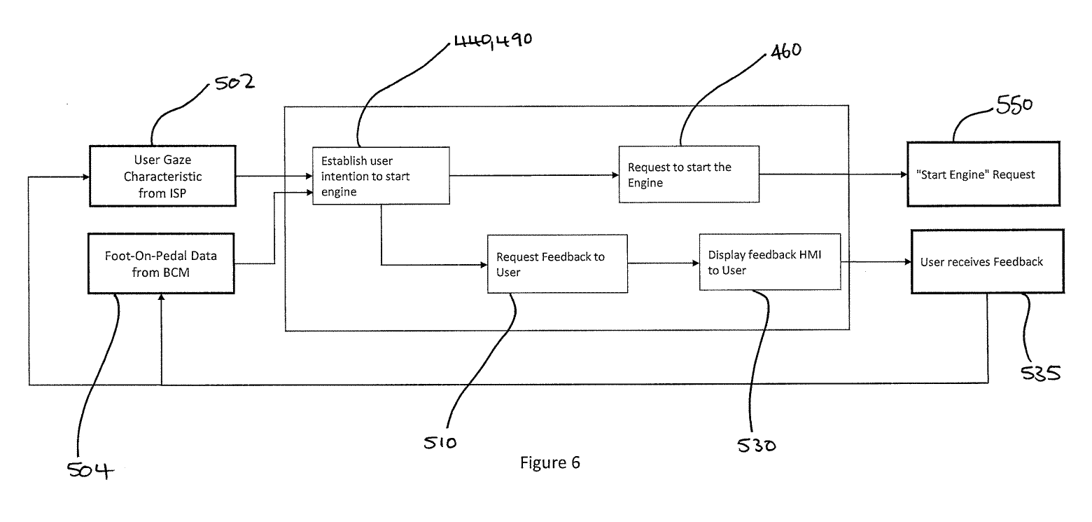

The controller 160 generates 510 a feedback signal 170 to the user when either the primary indication of intent or the secondary indication of intent is not identified. The feedback signal 170 enables feedback to be provided 530 (FIG. 6) to the user. In this case, the feedback is visual feedback. The visual feedback is a human machine interface. The feedback is displayed on an IPC display module 380 of the vehicle 300. The type of feedback provided to the user is discussed in more detail in relation to FIG. 7 and FIGS. 9A-9E.

FIG. 6 is a schematic illustration of the functions occurring within the set up described in relation to FIG. 5. That is, each box of the schematic illustration of FIG. 6 represents a function occurring.

At 502, user gaze characteristic data is sent from the ISP ECU 360. At 504, foot-on-pedal data is sent from the BCM 320. In this embodiment, the foot-on-pedal data is received by the input sensing component 180 of FIG. 5.

The user gaze characteristic data and the foot-on-pedal data are used to establish the primary and secondary indications of intent on a user to operate the vehicle 300. In this case, the user gaze characteristic data and the foot-on-pedal data are used to establish a user's intent to start an engine of vehicle 300, at 440, 490.

As discussed in relation to FIG. 5, once the primary and secondary indications of intent of the user to operate the vehicle 300 are identified, the controller 160 generates an activation signal 150, at 460 of FIG. 6. The activation signal 150 enables a request to start the engine of vehicle 300 to be generated 550.

If neither the primary indication of intent nor the secondary indication of intent are identified, the controller 160 generates a feedback signal 170 in order to provide 530 feedback to the user, at 510 and 530 of FIG. 6. The feedback is provided to the user as a human machine interface (HMI) on an IPC display module 380.

The type of feedback provided to the user is discussed in more detail in relation to FIG. 7 and FIGS. 9A-9E.

FIG. 7 is a flow chart illustrating in more detail the method 400′ of FIG. 4 and also the feedback referred to in relation to FIG. 6, 510, 530.

In common with FIG. 6, user gaze characteristic data and foot-on-pedal data are retrieved 502, 504. Feedback is then provided 530A to the user. In line with the embodiment of FIGS. 5 and 6, the feedback is provided as a human machine interface. In particular, the feedback provided 530A is human machine interface 1 (FIG. 9B).

Next, the user gaze characteristic data is compared to a predetermined gaze characteristic. If the user gaze characteristic complies with the predetermined gaze characteristic the “Yes” branch is followed and the user is provided with further feedback 530B. The feedback provided 530B is visual feedback as a human machine interface, that is, human machine interface 2 (FIG. 9C).

Next, a comparison of the user input to a predetermined input condition is carried out and if the user input complies with the predetermined input condition the “Yes” branch is followed and further feedback is provided 530C to the user. Feedback of 530C is a human machine interface, human machine interface 3 (FIG. 9D).

Next, a determination 520 of whether the user gaze characteristic complies with the predetermined gaze characteristic for a first predetermined time period and the user input complies with a predetermined input condition for a second predetermined time period. Following the “Yes” branch an activation signal is generated 460 to enable the user to operate the vehicle. In this case, primary and secondary indications of intent of the user to operate the vehicle are identified and a request 550 to start the engine of vehicle 300 is made.

Following the “No” branch, further feedback is provided 530E to the user. The further feedback may instruct the user so that the first and second predetermined time periods may be satisfied. For example, the further feedback may be human machine interface 2 (FIG. 9C) or human machine interface 3 (FIG. 9D).

Looking back to the earlier “No” branches of the flow chart, if it is determined that the user gaze characteristic does not comply with the predetermined gaze characteristic or that the foot is not on the pedal (user input does not comply with predetermined input condition) further feedback is provided 530D to the user. That is, human machine interface 3′ is provided to the user. Human machine interface 3′ has a counter. Human machine interface 3′ may also have instruction to the user so that the predetermined gaze characteristic and the predetermined input condition can be complied with. As an example, the counter of human machine interface 3′ counts up to make the user aware of the increasing time the user has to wait to enable operation of the vehicle. If the counter equals a predetermined threshold, that is, if enough time passes, further feedback is provided to the user, 530E. The further feedback may reset the counter of human machine interface 3′ or may be human machine interface 1 or 2.

However, if the user gaze characteristic complies with the predetermined gaze characteristic and the foot-on-pedal complies with the predetermined input condition before the counter equals the predetermined threshold, the feedback provided 530C to the user is human machine interface 3 (discussed in relation to FIG. 9D), which flows onto the assessment of whether the first and second predetermined time periods are complied with (that is, identification of primary and secondary indications of intent).

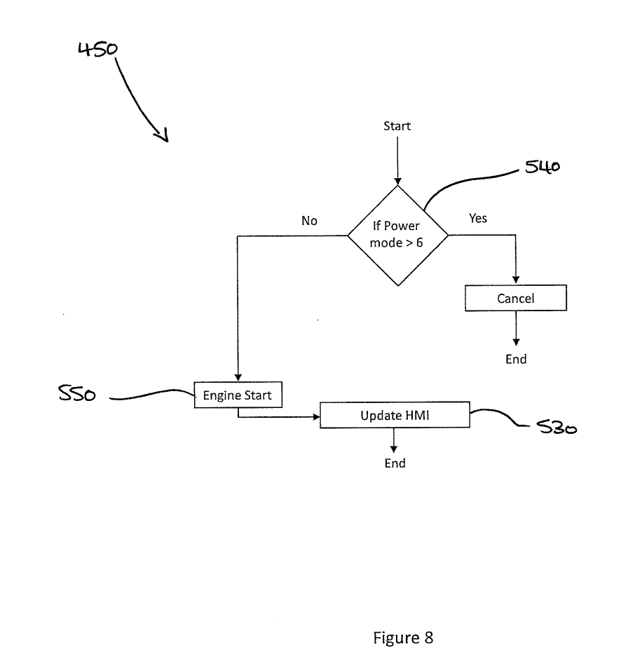

FIG. 8 is a schematic illustration of a power check method 450 that can occur within either method 400 of FIG. 3 or method 400′ of FIGS. 4 and 7.

At 540, a power check is made to ensure that the power mode of the vehicle 300 is above a predetermined threshold. In this case, the predetermined threshold is a power level that is below the power level of the vehicle when the vehicle is activated. For example, power level 6. If the “Yes” branch is followed vehicle 300 is already activated and, consequently, a request to start the engine is redundant. If the “No” branch is followed, the power mode of the vehicle 300 is low enough to allow an engine start 550. After the engine start 550 feedback provided 530 to the user is updated to the human machine interface of FIG. 9E.

FIGS. 9A-9E are examples of visual feedback provided to the user throughout the start-up process of the vehicle 300.

FIG. 9A is an example display shown on a human machine interface before initiation of the start-up process has occurred.

FIG. 9B is an example of feedback provided 530 to the user. FIG. 9B is human machine interface 1 (referred to in relation to FIG. 7) and provides instruction to the user.

FIG. 9C is human machine interface 2 (FIG. 7) and illustrates visual feedback representative of approaching threshold associated with the first predetermined time period. The visual feedback counter is a counter that, once started, counts down to the first predetermined time period. Alternatively, the counter may count down to a threshold that is equal to the sum of the first and second predetermined time periods.

FIG. 9D is an example of feedback provided 530 to the user. FIG. 9D is human machine interface 3. The circular shape of FIG. 9D is the counter of FIG. 9C which has started counting down to inform user of approach to enabling of vehicle operation.

Human machine interface 3 may be modified slightly to include a counter that increases—human machine interface 3′.

FIG. 9E is an example of the feedback provided 530 to the user after a request to start the engine of vehicle 300 has been generated.

FIG. 9F is an example of a human machine interface provided to the user when the identification module of the user, i.e., the smart key is not recognised by the vehicle 300.

FIG. 10 is a side view of a vehicle in accordance with an embodiment of the invention. Vehicle 300 includes the control system 200 of FIG. 2.

The predetermined target location, T, is an interior location of the vehicle 300 and is illustrated by the dashed line.

Specifically, the interior target location, T, is set to overlay the instrument cluster. However, alternatively, the interior target location T may be set to overlay one of the following: a steering wheel, a mirror, a dashboard, a glove box, a screen, a portion of a windshield, or an air vent.

The gaze sensing component 120 is a camera. The camera 120 is located centrally within the target location, T. In a slight variation, the gaze sensing component 120 may be two or more cameras. Each camera of the gaze sensing component may be offset from the target location, T, or at least one camera may be located within the target location T.

Optionally, the control system 200 comprises a pre-controller 165 in which the pre-controller 165 is configured to identify an authorised user within the vehicle 300 and where the controller 160 is configured to generate the activation signal 150 after the pre-controller 165 identifies an authorised user.

The identification of an authorised user before generation of the activation signal 150 increases the security of the control system 200 by ensuring the vehicle 300 is not being operated by an unauthorised user.

In an embodiment, the pre-controller 165 is configured to detect an identification module within the vehicle 300. The identification module is a key fob or smart key. If a smart key is not detected the user is presented with feedback. For example, the human machine interface of FIG. 9F.

Notwithstanding that some of the foregoing embodiments describe sending an engine start request in dependence on issuance of the activation signal 150, the skilled person will readily appreciate that this is not intended to limit the present invention to vehicles comprising internal combustion (IC) engines. In this respect the term ‘engine’ is intended to cover all vehicle prime-movers, for example, but not limited to, electrical machines. According to certain embodiments, issuance of the activation signal enables activation of an electric machine of the vehicle; alternatively the activation signal enables the vehicle to transition from a lower power mode to a higher power mode; further alternatively, the activation signal enables the vehicle to transition into a mode that allows a user to drive the vehicle. Optionally, the activation signal allows the vehicle to transition from a stationary state to a moving state.

Many modifications may be made to the above examples without departing from the scope of the present invention as defined in the accompanying claims.

1. A control system for enabling operation of a vehicle, the control system comprising:
a gaze sensing component;
a processor communicatively coupled to the gaze sensing component; and
a controller communicatively coupled to the processor;
wherein:
the gaze sensing component is configured to detect a gaze characteristic of a user of the vehicle and send data representative of the gaze characteristic to the processor;
the processor is configured to identify a primary indication of intent of the user to operate the vehicle when the user gaze characteristic complies with a predetermined gaze characteristic for a first predetermined time period;
the controller is configured to generate an activation signal to enable operation of the vehicle in dependence on the identified primary indication of intent;
the controller is further configured to generate a feedback signal to enable feedback to be provided to the user based on the user gaze characteristic; and
upon identification by the processor that the user gaze characteristic complies with the predetermined gaze characteristic, the controller is configured to generate a feedback signal to enable feedback representative of approaching a threshold associated with the first predetermined time period.

2. The control system of claim 1, wherein the feedback is at least one of the following: visual feedback, audio feedback, and haptic feedback.

3. The control system of claim 1, wherein upon identification by the processor that the user gaze characteristic does not comply with the predetermined gaze characteristic within the first predetermined time period, the controller is configured to reset the feedback signal.

4. The control system of claim 1, wherein the user gaze characteristic comprises eye movement of the user and the predetermined gaze characteristic comprises predetermined eye movement of the user.

5. The control system of claim 1, wherein the gaze characteristic of a user comprises a gaze direction of the user and the predetermined gaze characteristic comprises a predetermined gaze direction to a predetermined target location T.

6. The control system of claim 5, wherein the predetermined target location T is an interior location of the vehicle.

7. The control system of claim 6, wherein the interior location is associated with one of the following: an instrument cluster, a steering wheel, a mirror, a dashboard, a glove box, a screen, a portion of a windshield, or an air vent.

8. The control system of claim 1, wherein the user gaze characteristic comprises an iris feature of the user and the predetermined gaze characteristic comprises a predetermined iris feature.

9. The control system of claim 1, wherein the gaze sensing component comprises at least one camera.

10. The control system of claim 1, further comprising an input sensing component communicatively coupled to the processor;
wherein:
the input sensing component is configured to detect an input from the user and send data representative of the input to the processor;
the processor is configured to identify a secondary indication of intent of the user to operate the vehicle when the input from the user complies with a predetermined input condition for a second pre-determined time period; and
the controller is configured to generate the activation signal in dependence on the primary indication of intent and the secondary indication of intent.

11. The control system of claim 10, wherein the input sensing component is one of the following: a capacitive sensor; a pressure sensor; and an audio sensor.

12. The control system of claim 10, wherein the input sensing component is associated with one of the following: a clutch pedal; a brake pedal, and a steering wheel.

13. The control system of claim 1, further comprising a pre-controller, wherein the pre-controller is configured to identify an authorised user within the vehicle; and wherein the controller is configured to generate the activation signal after the pre-controller identifies an authorised user.

14. The control system of claim 13, wherein the pre-controller is configured to detect an identification module within the vehicle.

15. A vehicle comprising the control system of claim 1.

16. A method for enabling operation of a vehicle, the method comprising:
detecting a user gaze characteristic of a user of the vehicle;
identifying a primary indication of intent of the user to operate the vehicle when the user gaze characteristic complies with a predetermined gaze characteristic for a first predetermined time period;
generating an activation signal to enable operation of the vehicle in dependence on the primary indication of intent;
generating a feedback signal to enable feedback to be provided to the user based on the user gaze characteristic; and
upon identification by the processor that the user gaze characteristic complies with the predetermined gaze characteristic, generating a feedback signal to enable feedback representative of approaching a threshold associated with the first predetermined time period.

17. The method of claim 16, further comprising:
detecting an input from the user of the vehicle;
identifying a secondary indication of intent of the user to operate the vehicle when the input from the user complies with a predetermined input condition for a second predetermined time period; and
generating the activation signal to enable operation of the vehicle in dependence on the primary indication of intent and the secondary indication of intent.

18. A controller for a control system enabling operation of a vehicle, the controller configured to:
receive an input signal indicative of a primary indication of intent of a user to operate the vehicle, wherein the primary indication of intent is determined when a user gaze characteristic complies with a predetermined gaze characteristic for a first predetermined time period;
generate an activation signal to enable operation of the vehicle in dependence on the received input signal; and
generate a feedback signal to enable feedback representative of approaching a threshold associated with the first predetermined time period.

19. A computer program product comprising instructions which, when executed by a computer, cause the computer to perform the method of claim 16.

20. A non-transitory computer-readable medium having stored thereon the computer program product of claim 19.
